(19) United States
(12) Patent Application Publication
(10) Pub. No.: US 2001/0025287 A1
(43) Pub. Date: Sep. 27, 2001

(54) Document integrated management apparatus and method

(76) Inventors: Toshiaki Okabe, Kawasaki-shi (JP); Ryouji Taguchi, Kawasaki-shi (JP); Yoichi Hirose, Kawasaki-shi (JP); Satoshi Nojiri, Kawasaki-shi (JP)

Correspondence Address: Oliff & Berridge, PO Box 19928, Alexandria, VA, 22320, US

(21) Appl. No.: 09/725,765

(22) Filed: Nov. 30, 2000

(30) Foreign Application Priority Data
Mar. 16, 2000 (JP) 2000-073634

(51) Int. Cl. G06F 15/00

(52) U.S. Cl. 707/511

(57) ABSTRACT

A document integrated management apparatus which manages documents, stored in plural databases controlled by different applications, based on linkage of the documents. A linkage information manager manages linkage information of documents stored in the plural databases managed by the different applications or document sets each having one or more documents linked to each other, and a document information manager manages document information on the documents or document sets. When a client designates a document set, a search is performed on the document information and the linkage information, and the client can extract a document linked to the document set. Thus document extraction or search can be performed without consciousness of control applications of the databases holding the respective documents.

### BACKGROUND OF THE INVENTION

1. Field of the Invention

The present invention relates to a document integrated management apparatus and method, and specifically, to a system for integrated management on plural documents in a construction where various documents such as documents and drawings are managed by independent databases. More particularly, the present invention relates to a document integrated management apparatus and method providing a construction for efficient document integrated management to independently manage linkage information and document information on various documents stored in the databases controlled by various types of applications.

2. Description of the Related Art

Generally, in many business fields, documents are generated as complex documents integrated from independently-generated instructions, design drawings, pictures, various manuals, specifications and the like. Each of such instructions, design drawings, pictures, various manuals, specifications and the like are independently generated in respective document-generating offices, and stored into databases independently constructed in the respective offices. Usually the respective databases are controlled with applications respectively specific to the databases.

In this environment, in a case where documents generated by the respective offices are integrated into one document, first, necessary documents are read from the databases managed in the respective offices by the control applications of the databases, then, related drawings, related manuals and the like are read from other databases managed by applications specific to the databases, in accordance with the applications, and when all the related documents have been extracted, the documents are integrated into one set.

Further, in a case where a product is manufactured and sold, a series of operations of planning, proposal, designing, design change, plural approval processing, production, physical distribution, sales, support, sales information management and the like is often sequentially developed. In these processes, various processing on documents related to the product such as addition of new documents, deletion of unnecessary documents, or update of generated document is required. In the environment using distributed databases, the addition, deletion and update processing are also performed in the respective databases managed by the respective applications in the respective offices.

In this document management system, when there is a request to read a specific drawing related to a product, processing to find a database holding the drawing is necessary, and further, processing to start the specific application controlling the database is necessary to read the desired drawing. Further, in a case where the drawing is corrected and the updated drawings are stored in the database, processing to manage linkage of the updated drawing and the product is necessary. In a system without specific management database, the update processing or the like is managed only by the database holding the drawing, and regarding the occurrence of the updated drawing, no data is inputted into other databases holding the related documents. Accordingly, when a new integrated document is generated, it is necessary to perform processing to search the databases managed by the respectively specific applications to extract necessary related documents again to integrate them.

Several techniques have been proposed to improve convenience in handling plural documents. As a conventional technique to manage plural documents in accordance with linkage among them, Japanese Published Examined Patent Application No. Hei 6-87241 discloses “Document Attribute Discrimination Method”. The method manages documents by utilizing attributes added to the respective documents. A vector relation characteristic object including document attributes of at least two documents is generated. As the respective document attributes are stored in the generated vector relation characteristic objects, access to related documents based on designation of attribute can be made with high efficiency.

Further, Japanese Published Unexamined Patent Application No. Hei 10-21220 discloses “Document Editing Apparatus and Document Management Method” to allot numbers to documents related to each other, and perform print processing and editing processing based on the order.

However, the above Japanese Published Examined Patent Application No. Hei 6-87241 and Japanese Published Unexamined Patent Application No. Hei 10-21220 do not disclose processing nor a management method in a case where the plural documents to be linked to each other are independently stored in databases under the control of different applications, and further, do not implement integrated management in a distributed management system.

### SUMMARY OF THE INVENTION

The present invention has been made in consideration of the above situation, and to implement a system to manage various documents stored in databases controlled by respective independent applications while linking the documents with each other, provides a document integrated management apparatus and method to perform efficient extraction, editing, browsing on plural distributed documents, by setting document sets each linking data of various types of documents, drawings and the like distributed in plural independent databases, and by independently managing document information and linkage information on the respective documents and document sets.

According to one aspect of the present invention, the document integrated management apparatus which performs integrated management on plural documents stored in plural databases managed by controllers unique to the databases, respectively, has: a linkage information management unit that stores and manages linkage information among documents stored in the plural databases or document sets each having one or more documents as documents related to each other; and a document information management unit that stores and manages document information on the document sets each having one or more documents as documents related to each other, the documents being stored in the plural databases, wherein the linkage information and the document information are linked to each other by identifiers of the document sets.

Further, according to another aspect of the present invention, the respective controllers of the plural databases have control configurations based on different database management applications, and the document integrated management apparatus determines an access target database by searching for the document information and the linkage information, based on designation of document or document set or search data inputted in a common format from a client system, and outputs a processing command to the controller of the determined database.

Further, according to another aspect of the present invention, the linkage information includes a document set identifier, a document identifier for identification of a document or a document of document set linked to the document set, and a database identifier indicating a database holding the document or document set specified by the document identifier, and wherein the document information includes a document set identifier and linkage information of the document set, further, a document or document set corresponding to a document set identifier selected from the document information is selected from the linkage information, then an access target database is selected from the plural databases based on a database identifier in the linkage information of the selected document or document set, and the document identifier is outputted to the controller of selected database.

Further, according to another aspect of the present invention, the document integrated management apparatus further includes an archive management unit that manages archive information that associates the database identifier with the corresponding database, wherein the archive management unit specifies the access target database based on the database identifier selected based on the linkage information.

Further, according to another aspect of the present invention, the archive information indicates linkage between the database identifier and any of document type information of a leaf document or a document set as a single document, and if access target information is a leaf document, the document information management unit outputs a document identifier to designate the leaf document to the controller of the access target database, while if the access target information is a document set, obtains document information corresponding to the document set.

Further, according to another aspect of the present invention, the document information includes a history identifier as history information of a document or document set, and the linkage information includes a history identifier as history information of a document or document set and linkage type data as linkage data of relation of the document or document set to a relation source, indicating details of history.

Further, according to another aspect of the present invention, the controller of each of the plural databases has a converting unit that converts designation of document or document set or search data, inputted in a common format from a client system, into designation of document or document set or search data unique to the database.

According to another aspect of the present invention, the document integrated management method, for performing integrated management on plural documents stored in plural databases managed by controllers unique to the databases, respectively, has the steps of: storing linkage information among documents stored in the plural databases or document sets each having one or more documents as related documents; and storing document information on the document sets each having one or more documents as related documents, the documents being stored in the plural databases, wherein the linkage information and the document information are stored as data linked to each other with identifiers of the document sets.

Further, according to another aspect of the present invention, the document integrated management method, for performing integrated management on plural documents stored in plural databases managed by controllers unique to the databases, respectively, has the steps of: selecting a document set identifier by searching document information on document sets having one or more documents as related documents, said documents being stored in the plural databases, based on designation of document or document set or search data inputted in a common format from a client system; and selecting an access target database by searching linkage information among the documents stored in the plural databases or the document sets as one or more documents as related documents, based on the selected document set identifier.

Further, according to another aspect of the present invention, the document integrated management method further includes the step of extracting a document identifier of a document or document set from the linkage information and outputting the identifier to the controller of the access target database.

Further, according to another aspect of the present invention, the document integrated management method further includes the step of searching archive information including the database identifier and document type information indicating a leaf document or a document set as a single document or document set, linked to each other, and if the access target information is a leaf document, a document identifier to designate the leaf document is outputted to the controller of the access target database, while if the access target information is a document set, document information corresponding to the document set is obtained.

Further, according to another aspect of the present invention, the document integrated management method further includes the step of converting designation of document or document set or search data, inputted in a common format from a client system, into designation of document or document set or search data unique to the database.

Further, according to another aspect of the present invention, in a medium to provide a computer program to perform, on a computer system, document integrated management processing for integrated management on plural documents stored in plural databases managed by controllers unique to the databases, respectively, the computer program has code for: a step of storing linkage information among documents stored in the plural databases or document sets each having one or more documents as related documents; a step of storing document information on the document sets each having one or more documents as related documents, the documents stored in the plural databases; and a step of storing the linkage information and the document information as data linked to each other with identifiers of the document sets.

Further, according to another aspect of the present invention, in a medium to provide a computer program to perform, on a computer system, document integrated management processing for integrated management on plural documents stored in plural databases managed by controllers unique to the databases, respectively, the computer program has code for: a step of selecting a document set identifier by searching document information on document sets having one or more documents as related documents, the documents being stored in the plural databases, based on designation of document or document set or search data inputted in a common format from a client system; and a step of selecting an access target database by searching linkage information among the documents stored in the plural databases or the document sets as one or more documents as related documents, based on the selected document set identifier.

The medium to provide the program in the above aspects provides, e.g., a computer program in a computer-readable format to a general computer system capable of execution of various program code. Thus the form of the medium is not particularly limited. For example, the medium may be a storage medium such as CD, FD and MO, or a transmission medium such as network.

Such a medium to provide the program defines a structural or functional cooperative relation between the computer program and the medium to realize a predetermined function of the computer program on the computer system. In other words, the cooperative operation is performed on the computer system by installing the computer program via the medium into the computer system, thus advantages similar to those in the other aspects of the present invention can be obtained.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the construction of a document integrated management apparatus of the present invention;

FIG. 2 is an explanatory view of the concept of processing by the document integrated management apparatus;

FIGS. 3A and 3B are tables showing examples of the structure of data (system-defined attribute data) stored in a document information database of the document integrated management apparatus;

FIGS. 4A and 4B are tables showing examples of the structure of data (user-defined attribute data) stored in the document information database of the document integrated management apparatus;

FIG. 5 is a table showing examples of the structure of data stored in a linkage information database of the document integrated management apparatus;

FIG. 6 is an explanatory view of the linkage in a linkage information database;

FIG. 7 is a table showing an example of the structure of data stored in an archive information database of the document integrated management apparatus;

FIG. 8 is an explanatory view of document access processing on an archive in the document integrated management apparatus;

FIG. 9 is an explanatory view of search processing on the archive in the document integrated management apparatus;

FIG. 10 is a flowchart showing the document access processing on the archive in the document integrated management apparatus;

FIG. 11 is a flowchart showing the search processing on the archive in the document integrated management apparatus; and

FIG. 12 is a flowchart showing processing for document-set generation and update by the document integrated management apparatus.

### DETAILED DESCRIPTION OF THE PREFERRED EMBODIMENT

A preferred embodiment of the document integrated management apparatus and method according to the present invention will now be described in detail in accordance with the accompanying drawings.

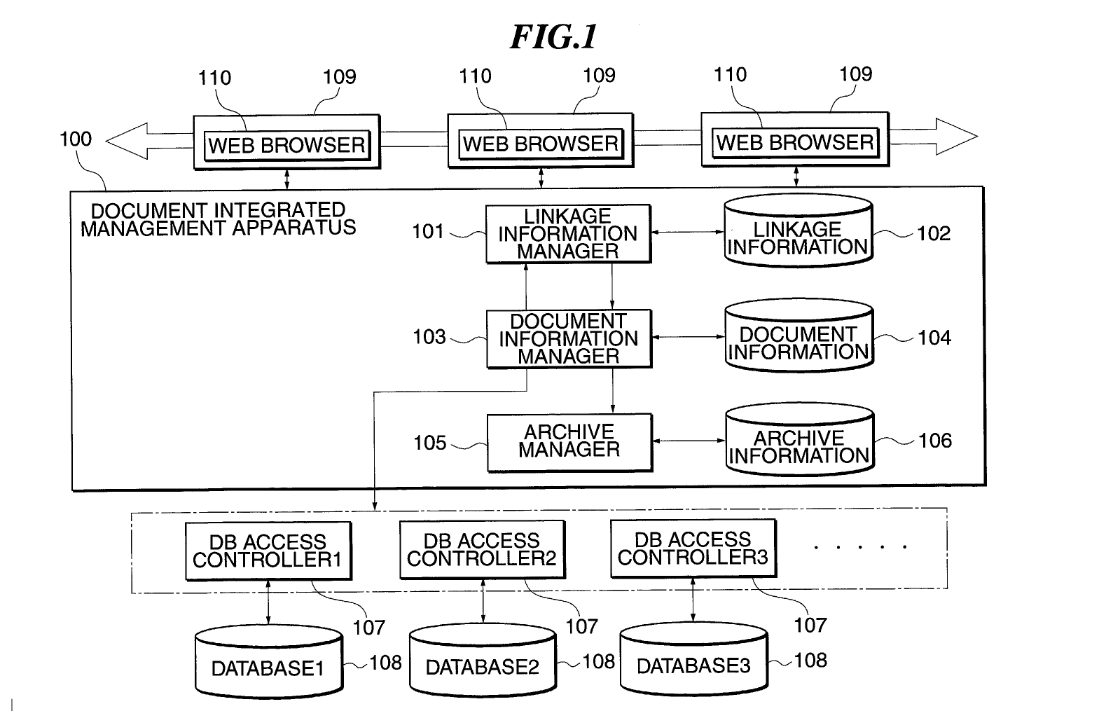

An embodiment of the document integrated management apparatus of the present invention will be described with reference to FIG. 1. As shown in FIG. 1, a document integrated management apparatus 100 of the present invention is a system for performing integrated management on data stored in plural databases 108 managed by respectively different database control applications. Respective client systems 109 display data via WEB browsers 110. Further, the client systems 109 perform processing such as extraction, search, editing, update, storage on the data stored in the databases 108 via the document integrated management apparatus 100 by data input via data input device such as a keyboard or a mouse (not shown), utilizing the display by the WEB browsers 110. Note that the WEB browser is an example of user interface, and it may be other display constructions than the WEB browser.

Independently-generated plural documents such as instructions, design drawings, pictures, various manuals and specifications are stored in the respective databases 108 under the control of the respective database management applications. In FIG. 1, the respective database management applications are represented as DB (database) access controllers 107. The DB access controllers 107 are respectively a text document management application, a drawing management application and the like. The document integrated management apparatus 100 manages in an integrated manner data in the databases 108 managed by the plural different types of applications.

As shown in FIG. 1, the document integrated management apparatus 100 has a linkage information manager 101, a linkage information database 102, a document information manager 103, a document information database 104, an archive (database) manager 105 and an archive information database 106.

Prior to a description of the respective constituent elements, a document set managed by the document integrated management apparatus 100 of the present invention and respective documents constructing the document set will be briefly described.

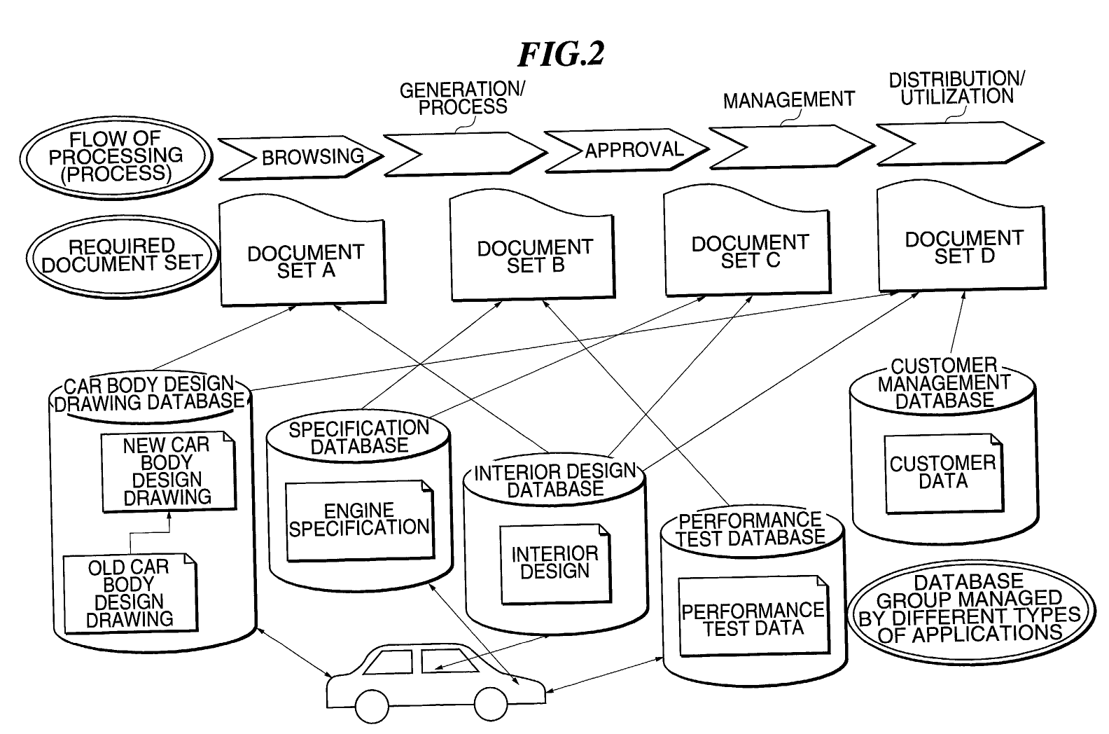

FIG. 2 shows an example of documents managed by the document integrated management apparatus 100 of the present invention. In this example, a “car” as a product is developed, manufactured and sold. In processes of development, determination of the design, manufacture of the product and distribution of catalog for sales, various documents and figures are generated. These documents are stored in management databases in different offices.

In the example in FIG. 2, the databases are a body design drawing database, a specification database, an interior design database, a performance test database and a customer management database managed by respectively different applications.

The various data stored in the respective databases are used in respective “browsing”, “generation/process”, “approval”, “management” and “distribution/utilization” process steps shown in an upper part of FIG. 2. Here a set of one or more necessary documents used at each step is called a document set. In the respective process steps, various formats of document sets are used.

For example, a document set A includes a body design drawing extracted from the body design drawing database and interior design data extracted from the interior design database. Further, a document set B includes a specification extracted from the specification database and performance test data extracted from the performance test database.

A user to utilize a document set at each process step displays documents constructing the document set, i.e., only necessary documents, on the WEB browser, and performs various necessary processing, e.g., editing, approval and printing.

The document integrated management apparatus of the present invention performs extraction and processing on documents independently managed in such various databases, based on designated data or search data inputted in a common format from a client device, without consciousness of control applications of the respective databases.

Returning to FIG. 1, the details of the linkage information manager 101, the linkage information database 102, the document information manager 103, the document information database 104, the archive (database) manager 105 and the archive information database 106 constructing the document integrated management apparatus 100 will be described.

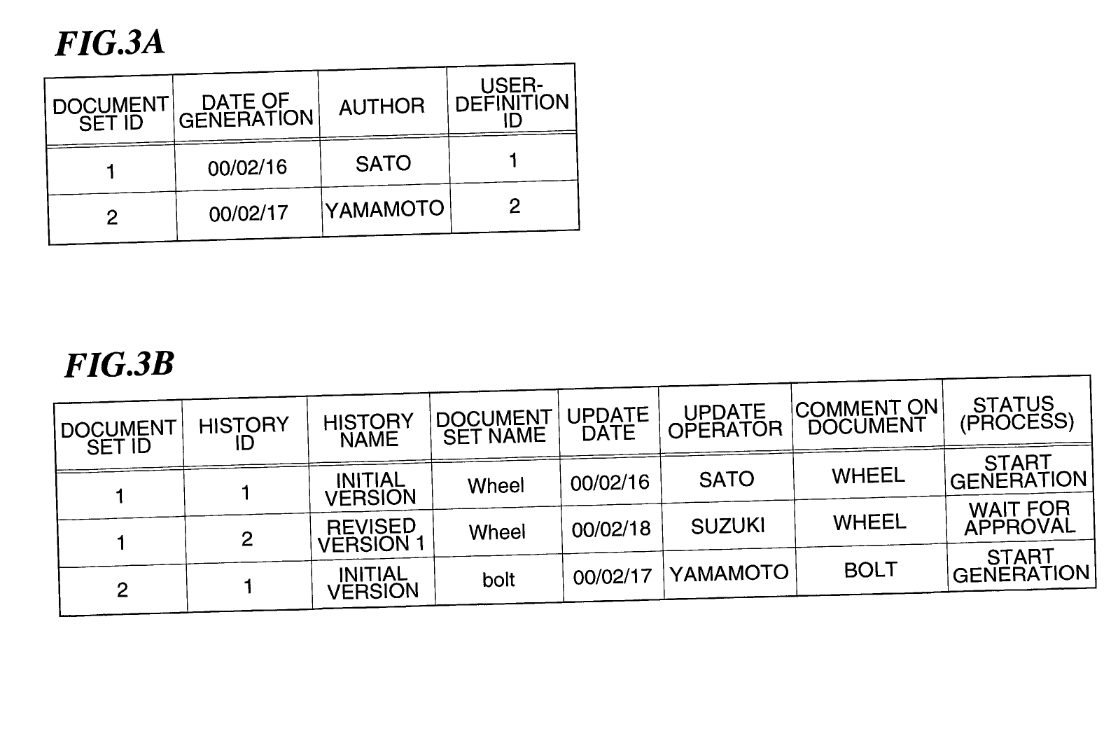

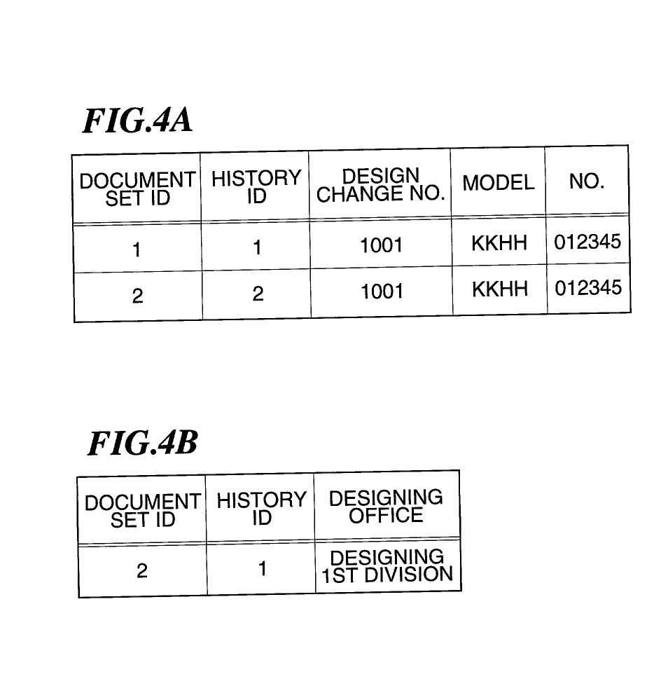

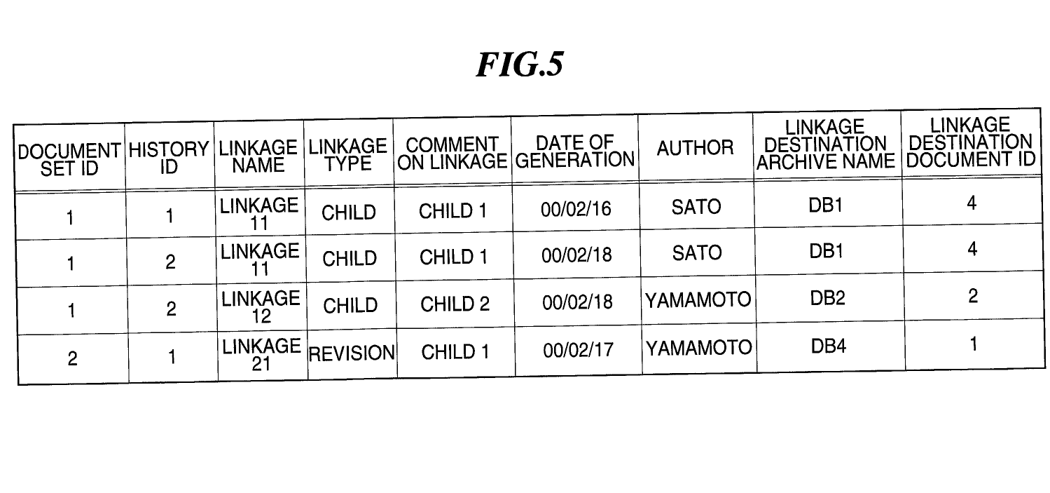

First, the data structure of data stored in the document information database 104 managed by the document information manager 103 will be described with reference to FIGS. 3A, 3B, 4A and 4B. The document information managed by the document information manager 103 is information of documents stored in the databases 108 in FIG. 1 or information on the document sets each having one or more documents as documents related to each other. The document information has system-defined attribute data defined by the system as common data, and user-defined attribute data in which a user can arbitrarily set a field and store data therein. FIGS. 3A and 3B show the system-defined attribute data, and FIGS. 4a and 4B, the user-defined attribute data.

FIGS. 3A shows the system-defined attribute data in a data format without history management, and FIG. 3B, the system-defined attribute data in a data format with history management. In the format without history management in FIG. 3A, the data has a “date of generation” field for storing the date of generation of a document set, an “author” field for storing the author's name, and a “user definition ID” field for storing an identifier of the user-defined attribute, linked to a document set ID as an identifier of the document set.

In the format with history management in FIG. 3B, the data has a “history ID” field indicating the update order of document or document set, a “history name” field indicating a particular history type such as an initial version or a revised version, and a “document set name” field, an “update date” field, an “update operator” field, a “comment on document” field, and further, a “status” field for storing data indicating the position in the process steps as described above, i.e., a status of waiting for approval, a status of document generation start, an already approved status or the like, in addition to the fields in FIG. 3A.

FIGS. 4A and 4B show examples of the user-defined attribute data in data stored in the document information database 104 managed by the document information manager 103. The user-defined attribute is a field in which the user sets arbitrary fields and stores data therein. In this example, the user-defined attribute data has data storage structure in a format corresponding to the ID set in the user definition ID field in FIG. 3A. FIG. 4A shows the user-defined attribute data in a format corresponding to a case where user definition ID=1 holds, having a “document set ID” field, a “history ID” field, a “design change No.” field, a “model” field, a “No.” field. FIG. 4B shows the user-defined attribute data in a format corresponding to a case where user definition ID=2 holds, having the “document set ID” field, the “history ID” field and a “designing office” field. Thus, the users can arbitrarily set the respective fields in accordance with document type.

In FIG. 1, the client system 109 which is to perform processing, such as editing or browsing, on a document set or documents constructing the document set via the WEB browser 110, first accesses the document information database 104 managed by the document information manager 103. The document information manager 103 manages attribute data of documents stored in the plural databases managed by the database access controllers 107 controlled by various applications as shown in FIG. 1. These attribute data pieces are managed in an integrated manner as document information in the formats as shown in FIGS. 3A, 3B, 4A and 4B.

The client system 109 can read the document information (See FIGS. 3A, 3B, 4A and 4B) stored in the document information database 104 by accessing the document information manager 103 without operating the access controllers 107 controlled by various applications as shown in FIG. 1.

The client system 109 can read a necessary document set or documents constructing the document set by performing processing to designate the document set or to designate a particular word, period, ID or the like by designation of particular field in the document information as shown in FIGS. 3A and 3B, or by searching.

When the client system 109 access the document information manager 103 and designates the necessary document set or documents constructing the document set, by using the document attribute data stored in the document information database 104, processing to extract the document set/documents is performed.

At this time, the linkage information manager 101 and the linkage information database 102 in FIG. 1 execute one of significant processes in the extraction processing. The linkage information manager 101 and the linkage information database 102 generate linkage information indicating linkage among respective documents included in a document set and linkage among the document sets and hold the information. Further, document set linkage information indicating linkage between documents and document sets and linkage among document sets, storage database information indicating databases holding the respective documents, and pointer information as document access information in the databases holding the documents, are stored as primary data in the linkage information database. That is, the linkage information manager 101 and the linkage information database 102 hold and manage linkage information among the documents stored in the plural databases 108 or document sets each having one or more documents as documents related to each other.

FIG. 5 shows an example of data stored in the linkage information database 102 managed by the linkage information manager 101. As shown in FIG. 5, the data stored in the linkage information database 102 has a “document set ID” field holding a document set identifier, a “history ID” field indicating identification of update order or revision order of document set, “linkage name”, “linkage type” and “comment on linkage” fields indicating position of the document in the document set, a “date of generation” field indicating the date of generation of the document, an “author” field indicating a person who generated the document, and further, a “linkage destination archive name” field holding information on a database in which the document is stored, i.e., storage database information, and a “linkage destination document ID” field holding document access information in the database holding the document.

The linkage destination document ID is an ID which functions as an access pointer of the document. It is set as an identifier directly applicable or interpretable in the database access controller 107 in FIG. 1. That is, IDs which interpretable for the applications of the database controllers corresponding to the databases 108 holding the documents are set in advance as document IDs of the documents in the linkage information database. Accordingly, the user operating the client system 109 can read documents included in a necessary document set by processing by the document information manager 103 and the linkage information manager 101, without consciousness of these document IDs.

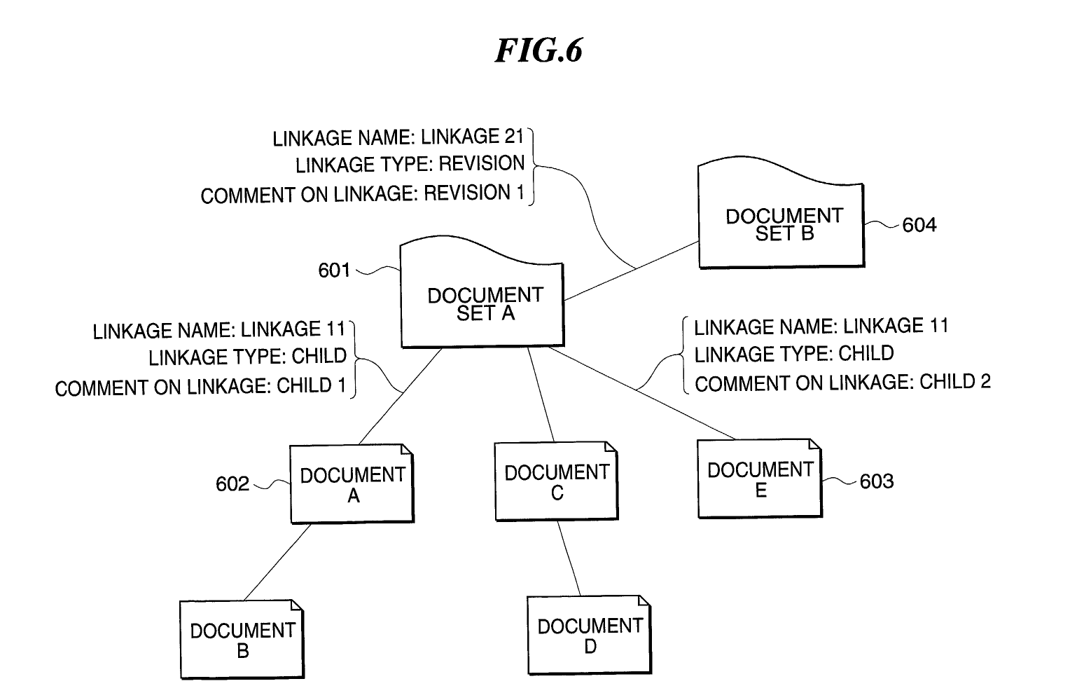

FIG. 6 shows an example of correlation among documents in a document set and correlation between document sets, set as linkage information. In FIG. 6, a document set A601 has various documents. For example, in relation between a document set 601 and a document 602, the linkage type of the document 602 is “child”, and “child 1” is set as a comment on linkage. The linkage type of a document 603 is also “child” of the document set 601, and as “child 2” is set as a comment on linkage. Further, when a document set B604 is generated as a revised document of the document set A601, the linkage type of the document set B604 is “revision”.

In this manner, the “linkage name” data, the “linkage type” data and the “comment on linkage” data stored in the linkage information database 102 managed by the linkage information manager 101 are set as data indicating the linkage between the document or document set and a document set identified by the “document set ID” indicated in the “linkage destination document ID” field of the data sample in FIG. 5.

In the linkage information database 102 managed by the linkage information manager 101, an access target database of document included in the document set is obtained from the “linkage destination archive name” field and the document access information in the database holding the document is obtained form the “linkage destination document ID” field, by using the document set ID designated in the document information.

The linkage destination archive (database) name, i.e., an archive (database) ID, obtained from the linkage information database 102 managed by the linkage information manager 101 is forwarded to the archive information manager 105. The archive information manager 105 manages the archive ID and the archive name (database name), and the document type of designated document, linked to each other, in the archive information database 106.

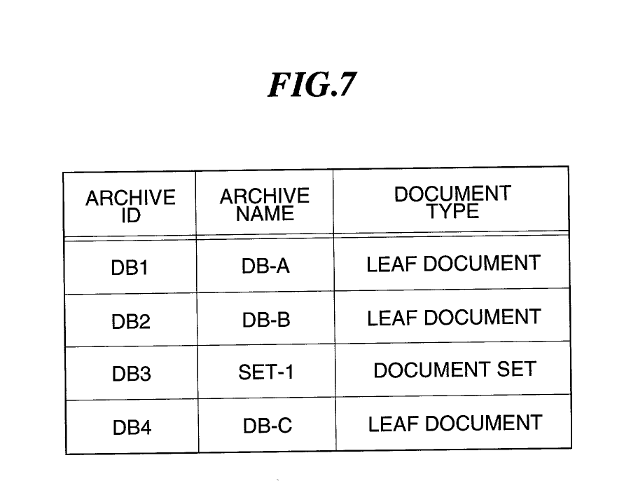

FIG. 7 shows an example of the structure of data stored in the archive information database 106. In the data FIG. 7, “archive ID”, “archive name” and “document type” are linked to each other. The “archive name” is set as a database access name to uniquely identify a database and available to access the database. The “document type” indicates the type of designated document as a document set having plural documents or a leaf document as a single document.

In the document information manager 103, the identifier of the document set including the document designated by the client system 109 via the WEB browser 110 is determined based on the data stored in the document information database 104 (See FIGS. 4A and 4B). Then, in the linkage information manager 101, the linkage destination archive (database) name and the linkage destination document ID are determined based on the document set identifier (ID) from the data stored in the linkage information database 102 (See FIG. 5). Further, in the archive manager 105, the access archive (database) name and the document type are obtained based on the data stored in the archive information database 106 (see FIG. 7).

In the document integrated management apparatus and method of the present invention, if the document type of access target document is leaf document, the linkage destination document ID obtained based on the data stored in the linkage information database 102 (See FIG. 5) is outputted as pointer information to obtain the document, to the database access controller 107 that manages the database corresponding to the archive (database) name obtained based on the data stored in the archive information database 106 (See FIG. 7).

The database access controller 107 that received the linkage destination document ID extracts the document based on the linkage destination document ID, then transfers the document via the document integrated management apparatus 100 and a WEB server (not shown) to the client system 109 that required the document. The document is displayed on the WEB browser 110.

On the other hand, if it is determined from the archive information (See FIG. 7) that the document type of access target document is not leaf document but document set, in order to enable the user's selection of document (leaf document) in the document set, the information of the designated document set stored in the document information database 104 is obtained by the document information manager 103, and the information is supplied to the client system 109. The client system 109 further selects a document from the document set as the object of processing such as browsing or editing, based on the document set information, and outputs the information to the document information manager 103, thus obtaining substantial data of the necessary document.

In the document integrated management apparatus and method of the present invention, the user who uses the client system 109 only performs document selection processing or search condition setting processing in accordance with a predetermined format (common format) set in the document integrated management apparatus, without consciousness of necessary address or search condition unique to the database 108 holding the necessary document, i.e., addresses and the like unique to the applications applied to the database access controllers 107 set in correspondence with the various databases 108. The conversion to unique address in each database access controller 107 is executed by the document information manager 103, the linkage information manager 101 and the archive manager 105.

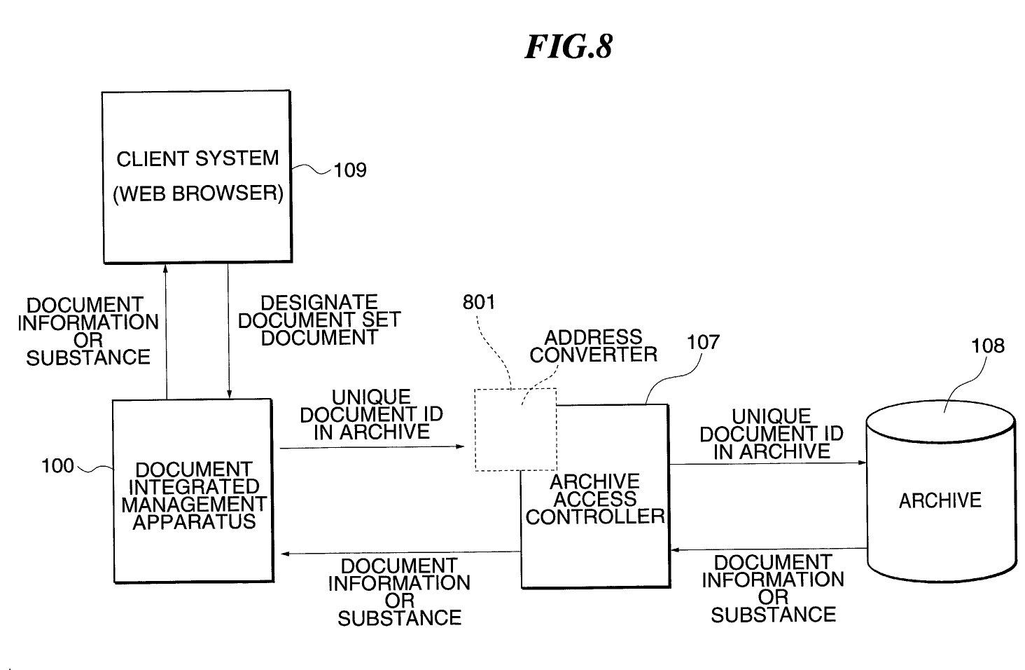

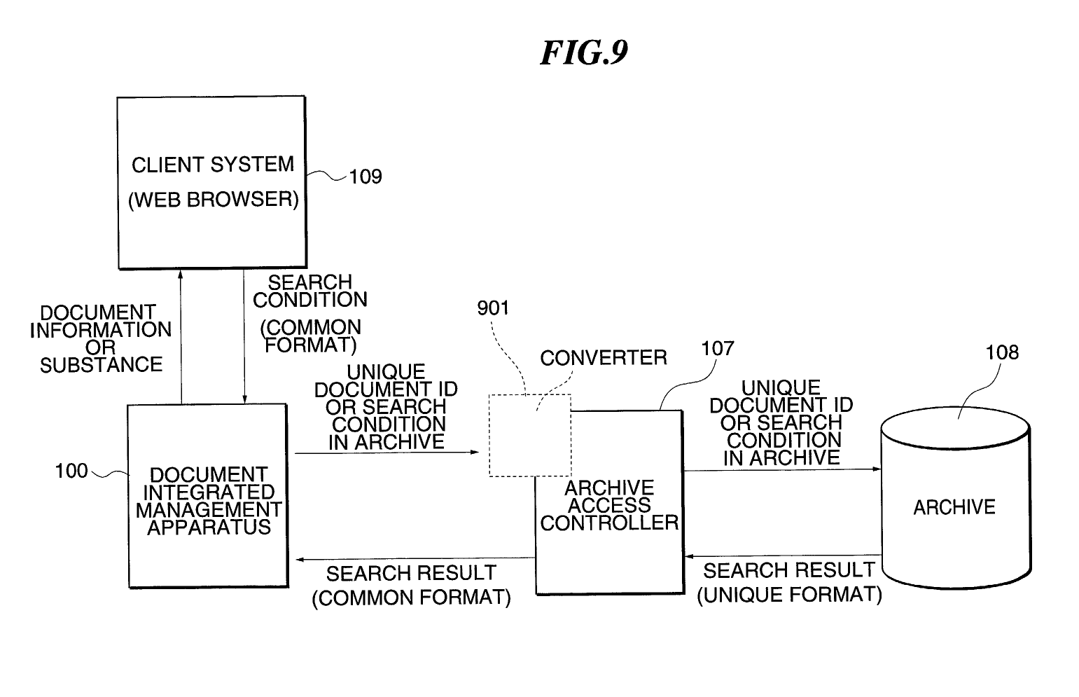

The data conversion in the processing to extract a document from the database, in the document integrated management apparatus of the present invention, will be described with reference to FIGS. 8 and 9.

In FIG. 8, the client system 109 designates a document set and inputs the designation into the document integrated management apparatus 100 of the present invention, then on the document integrated management apparatus 100, a document ID unique in the archive (database), i.e., one-to-one corresponding to a document in the database, is outputted to the archive access controller 107, in accordance with the above description. The archive access controller 107 that manages an archive specified by the archive information (See FIG. 7) receives the document ID.

The document ID generated in the document integrated management apparatus 100 corresponds to the linkage destination document ID stored in the linkage information database 102. When the document ID is outputted to the archive access controller 107 corresponding to the archive (database) specified by the archive information (See FIG. 7), the archive access controller 107 extracts the document from the archive (database) 108 based on the document ID. Note that it may be arranged such that the unique ID outputted from the document integrated management apparatus 100 to the archive access controller 107 is converted to an ID unique to the database then outputted to the database 108. In this case, an address converter 801 performs the conversion processing.

FIG. 9 shows processing to designate a search condition from the client system 109 and obtain a search target document or document set information. The client system 109 inputs the search condition in a common format independent of the respective database structures. The search condition is set in correspondence with data stored in the respective field of the document information and linkage information as shown in FIGS. 3 and 5. For example, designation of author or date of generation, or designation of document set ID, or combination thereof, can be the search condition.

In the document integrated management apparatus 100, a document set or leaf document corresponding to the search condition inputted in the common format from the client system 109 is selected, and the selected document set or leaf document is outputted to the archive access controller 107 in charge of the database holding the document set or leaf document. The processing is similar to the document extraction processing in FIG. 8.

Further, it may be arranged such that the search condition itself inputted in the common format from the client system 109 is outputted to the archive access controller 107, and the search conditional expression is converted to a conditional expression corresponding to the application unique to the database, and search is performed on the database in accordance with the converted search expression. In this case, a converter 901 similar to the address converter 801 in FIG. 8 is provided for execution of the conversion processing.

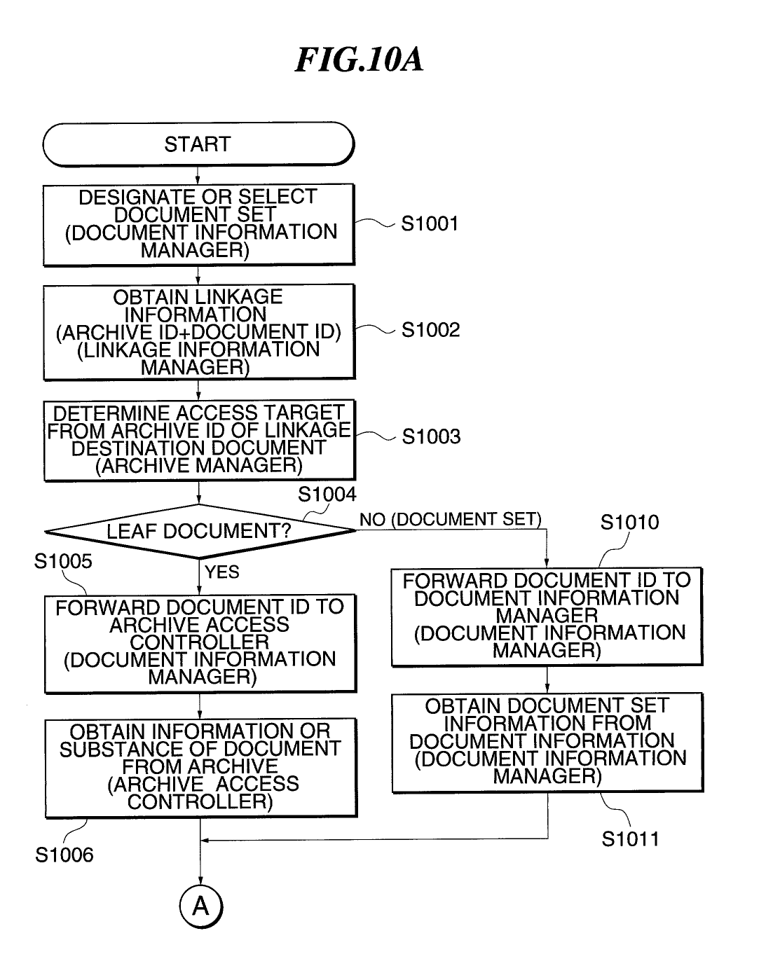

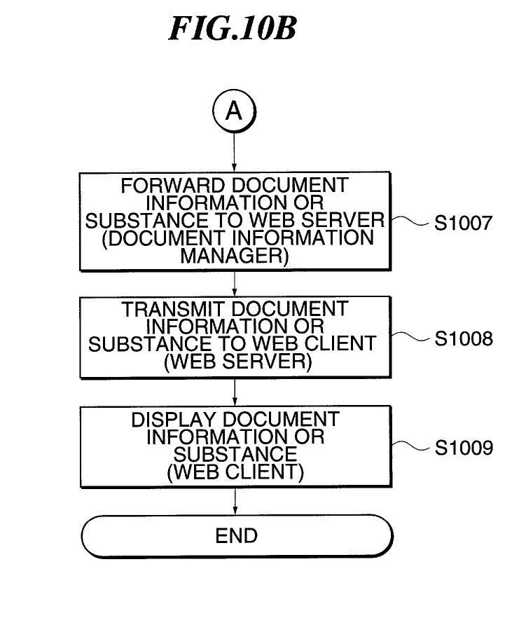

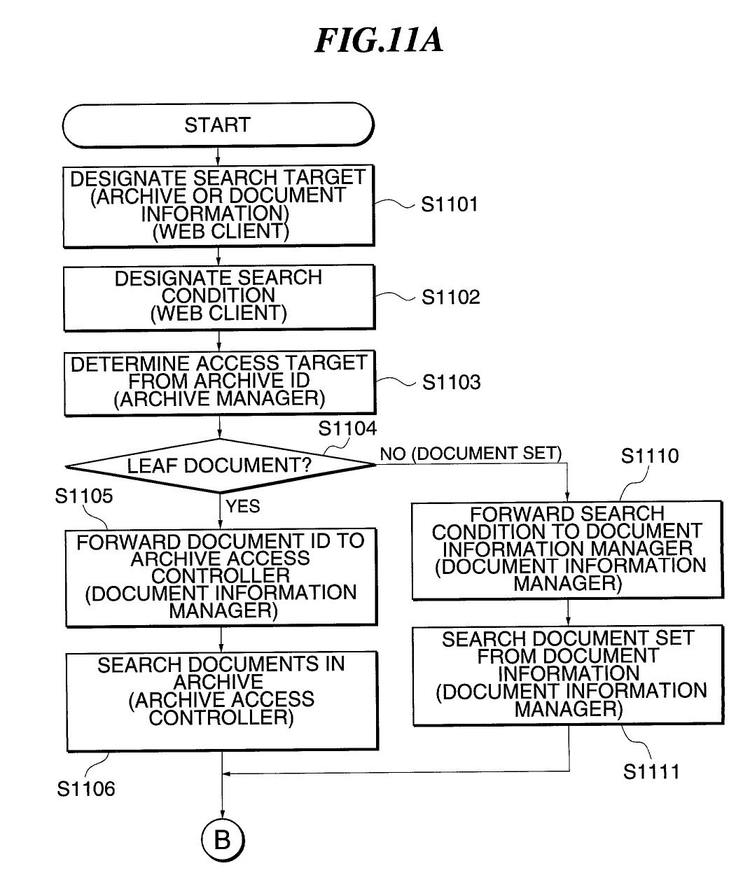

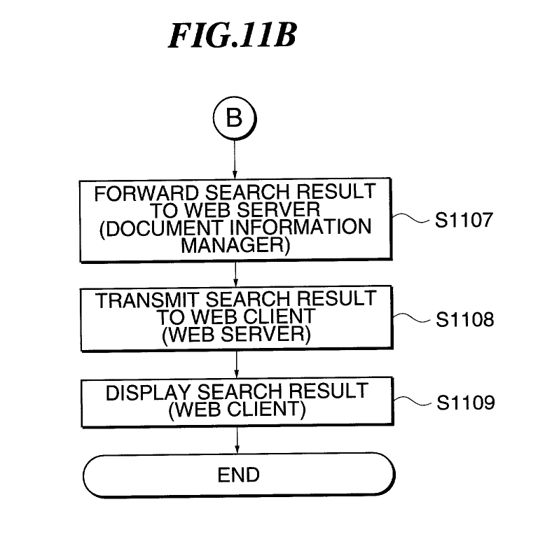

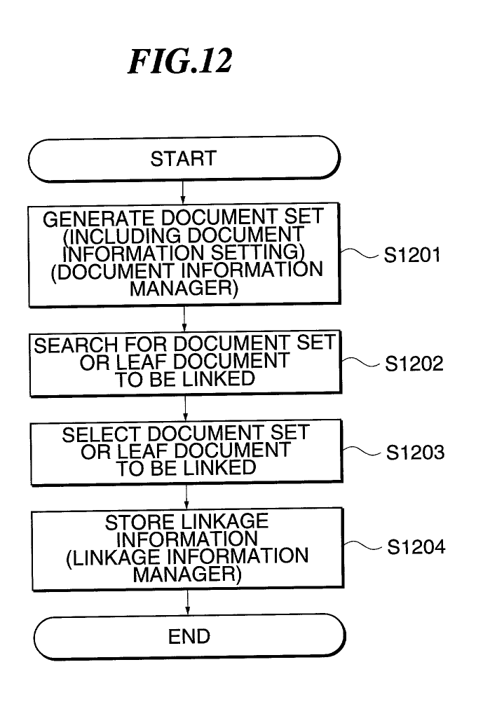

Next, the processing by the document integrated management apparatus of the present invention will be described with reference to the flowchart of FIGS. 10 to 12. FIG. 10 shows the processing to designate a document set or document (leaf document) by the client system and obtain substantial document or document set information, i.e., display the information on the WEB browser; FIG. 11, the search processing; and FIG. 12, the document set generation and update processing in the client system.

First, the flow of document set designation processing as shown in FIG. 10 will be described. At step S1001, the client system 109 performs designation or selection of document set. The designation is performed based on the data stored in the document information database 104 managed by the document information manager 103 in the document integrated management apparatus 100. Next, at step S1002, a document set identifier (ID) of the document set designated by the client system is outputted to the linkage information manager 101, and linkage information based on the document set ID is obtained.

Next, at step S1003, archive information (See FIG. 7) is obtained in the archive manager 105, based on a linkage destination archive name obtained based on the linkage information (See FIG. 5) obtained in the linkage information manager 101, thus the access target archive is specified.

Further, at step S1004, it is determined from the archive information whether the access target is a document set or a leaf document. If the access target is a leaf document, the process proceeds to step S1005, at which the document ID is outputted to the archive (database) access controller 107 managing the access target archive (database) determined at step S1003.

Next, at step S1006, the access target document is extracted based on the document ID, then the extracted document is outputted to the WEB server (step S1007), then transferred to the client system (step S1008), and displayed by the WEB browser 110 (step S1009).

If it is determined at step S1004 that the access target is a document set, the process proceeds to step S1010, at which the document ID is outputted to the document information manager 103, and document set information based on the document ID is obtained from the document information database 104 (step S1011). The obtained document set information is outputted to the WEB server (step S1007), then transferred to the client system 109 (step S1008), and displayed by the WEB browser 110 (step S1009).

FIG. 11 shows the process flow in a case where the client system 109 designates a search condition. As described above, the client system 109 inputs the search condition in a common format independent of the respective database structures. As the condition, data stored in arbitrary field(s) in the document information and linkage information can be set. For example, a document set ID, an author, a date of generation or the like, or combination thereof may be set as a search condition.

At step S1101, a search target is specified, i.e., archive or document information is specified as a search range. Further, at step S1102, the search condition is designated. These processing are performed by WEB browser 110 of the client system 109 in the common format independent of database type.

At step S1103, an archive ID as an access target is specified from the document information, the linkage information and the archive information, based on the search condition. Note that plural access targets may exist, and in this case, processing at step S1104 and the subsequent steps is performed in a parallel manner. At step S1104, it is determined whether or not the access target is a leaf document. If the access target is a leaf document, the process proceeds to step S1005, at which the document ID is outputted to the archive (database) access controller 107 managing the access target archive (database) determined at step S1103.

Next, at step S1106, the access target document is extracted based on the document ID, then the extracted document is outputted to the WEB server (step S1007), then transferred to the client system (step S1008), and displayed by the WEB browser 110 (step S1009).

If it is determined at step S1104 that the access target is a document set, the process proceeds to step S1110, at which the search condition is forwarded to the document information manager 103, and document set information based on the search condition is obtained from the document information database 104 (step S1111). The obtained document set information is outputted to the WEB server (step S1007), then transferred to the client system 109 (step S1008), and displayed (step S1009). Further, document designation can be made in the client system based on the obtained document set information.

Next, the processing to generate a document set and update a document set, more particularly, to link a new document to the document set, will be described with reference to FIG. 12.

At step S1201 in FIG. 12, document set generation is performed. More particularly, this processing is to access the document information manager 103 from the client system 109 and input the attribute information as shown in FIGS. 3A and 3B. Further, the user-defined attributes as shown in FIGS. 4A and 4B can be set. Next, at step S1202, a leaf document or document set to be linked to the generated document set is searched. The search is performed based on a desired search condition set by the client in accordance with the processing in FIG. 11.

At step S1203, a document set or leaf document to be linked is selected from the search result. Next, at step S1204, linkage information on the relation of the selected document set or leaf document is generated and stored. The linkage information includes, e.g., the linkage name, the linkage type and the comment on linkage set in the linkage information as shown in FIG. 5. The linkage information including such information is stored into the linkage information database 102, thus linkage processing on the document set is completed. Note that the flowchart of FIG. 12 shows processing to link a leaf document to a document set, however, linkage among document sets in “revision” relation, for example, may be made as similar processing.

In this manner, the document integrated management apparatus and method of the present invention performs document extraction or search on plural databases managed by various different applications, without consciousness of the applications, and sets various linkage in a document set for documents in the independent databases.

Note that the document integrated management apparatus enables similar processing between remote databases connected via a network. In this case, a client performs document extraction or search in a common format independent of control application of connected database, and the documents can be managed by using document sets.

As described above, in the document integrated management apparatus of the present invention, linkage information among independent documents or document sets is managed by the linkage information manager 101, the document information on the independent documents or document sets is managed by the document information manager 103 independent of the linkage information, and the information are linked to each other with document set identifiers. In this independent management structure, document management and linkage information management in drawing revision, instruction proof processing and the like which often occur in case of product designing, for example, can be independently performed efficiently, without execution of document information management and linkage information management in parallel.

Further, by setting the linkage information, linkage processing on the related documents upon each design change in design changing processing or the like can be easily performed. Further, by setting processing to distinguish a multilingual manual into respective languages as the linkage information, multiple documents stored in the plural databases constructing the manual can be easily managed.

As described above, according to the document integrated management apparatus and method of the present invention, a document can be extracted or searched from plural databases managed by various different applications without consciousness of the applications. Further, by managing documents stored in different databases as a document set and holding linkage information, the linkage among the respective documents in the independent databases can be obtained from document set information, thereby document selection or document extraction processing by designation of document set can be easily performed without consciousness of the control applications of the respective databases.

The present invention has been described in detail with reference to the particular embodiment, however, it is apparent to those skilled in the art to make various changes and modifications without departing from the spirit and scope thereof. That is, it is to be understood that the invention is not limited to the specific embodiment. Therefore, to appraise the public of the scope of the present invention, the following claims are made.

The entire disclosure of Japanese Patent Application No. 2000-073634 filed on Mar. 16, 2000 including specification, claims, drawings and abstract is incorporated herein by reference in its entirety.

What is claimed is:

1. A document integrated management apparatus which performs integrated management on plural documents stored in plural databases managed by controllers unique to the databases, respectively, comprising:
a linkage information management unit that stores and manages linkage information among documents stored in the plural databases or document sets each having one or more documents as documents related to each other; and
a document information management unit that stores and manages document information on the document sets each having one or more documents as documents related to each other, the documents being stored in the plural databases,
wherein the linkage information and the document information are linked to each other by identifiers of the document sets.

2. The document integrated management apparatus according to claim 1, wherein the respective controllers of the plural databases have control configurations based on different database management applications,
and wherein the document integrated management apparatus determines an access target database by searching for the document information and the linkage information, based on designation of document or document set or search data inputted in a common format from a client system, and outputs a processing command to the controller of the determined database.

3. The document integrated management apparatus according to claim 1, wherein the linkage information includes a document set identifier, a document identifier for identification of a document or a document of document set linked to the document set, and a database identifier indicating a database holding the document or document set specified by the document identifier,
and wherein the document information includes a document set identifier and linkage information of the document set,
further wherein a document or document set corresponding to a document set identifier selected from the document information is selected from the linkage information, then an access target database is selected from the plural databases based on a database identifier in the linkage information of the selected document or document set, and the document identifier is outputted to the controller of selected database.

4. The document integrated management apparatus according to claim 3, further comprising an archive management unit that manages archive information that associates the database identifier with the corresponding respective database,
wherein the archive management unit specifies the access target database based on the database identifier selected based on the linkage information.

5. The document integrated management apparatus according to claim 4, wherein the archive information indicates linkage between the database identifier and any of document type information of a leaf document or a document set as a single document,
and wherein if access target information is a leaf document, the document information management unit outputs a document identifier to designate the leaf document to the controller of the access target database, while if the access target information is a document set, obtains document information corresponding to the document set.

6. The document integrated management apparatus according to claim 1, wherein the document information includes a history identifier as history information of a document or document set,
and wherein the linkage information includes a history identifier as history information of a document or document set and linkage type data as linkage data of relation of the document or document set to a relation source, indicating details of history.

7. The document integrated management apparatus according to claim 1, wherein the controller of each of the plural databases has a converting unit that converts designation of document or document set or search data, inputted in a common format from a client system, into designation of document or document set or search data unique to the database.

8. A document integrated management method for performing integrated management on plural documents stored in plural databases managed by controllers unique to the databases, respectively, comprising the steps of:
storing linkage information among documents stored in the plural databases or document sets each having one or more documents as related documents; and
storing document information on the document sets each having one or more documents as related documents, the documents being stored in the plural databases,
wherein the linkage information and the document information are stored as data linked to each other with identifiers of the document sets.

9. A document integrated management method for performing integrated management on plural documents stored in plural databases managed by controllers unique to the databases, respectively, comprising the steps of:
selecting a document set identifier by searching for document information on document sets having one or more documents as related documents, the documents being stored in the plural databases, based on designation of document or document set or search data inputted in a common format from a client system; and
selecting an access target database by searching linkage information among the documents stored in the plural databases or the document sets as one or more documents as related documents, based on the selected document set identifier.

10. The document integrated management method according to claim 9, further comprising the step of extracting a document identifier of a document or document set from the linkage information and outputting the identifier to the controller of the access target database.

11. The document integrated management method according to claim 9, further comprising the step of searching archive information including the database identifier and document type information indicating a leaf document or a document set as a single document, linked to each other,
wherein if the access target information is a leaf document, a document identifier to designate the leaf document is outputted to the controller of the access target database, while if the access target information is a document set, document information corresponding to the document set is obtained.

12. The document integrated management method according to claim 9, further comprising the step of converting designation of document or document set or search data, inputted in a common format from a client system, into designation of document or document set or search data unique to the database.

13. A medium to provide a computer program to perform, on a computer system, document integrated management processing for integrated management on plural documents stored in plural databases managed by controllers unique to the databases, respectively, wherein the computer program comprising code for:
a step of storing linkage information among documents stored in the plural databases or document sets each having one or more documents as related documents;
a step of storing document information on the document sets each having one or more documents as related documents, the documents being stored in the plural databases; and
a step of storing the linkage information and the document information as data linked to each other with identifiers of the document sets.

14. A medium to provide a computer program to perform, on a computer system, document integrated management processing for integrated management on plural documents stored in plural databases managed by controllers respectively unique to the databases, wherein the computer program comprising code for:
a step of selecting a document set identifier by searching document information on document sets having one or more documents as related documents, the documents stored in the plural databases, based on designation of document or document set or search data inputted in a common format from a client system; and
a step of selecting an access target database by searching linkage information among the documents stored in the plural databases or the document sets as one or more documents as related documents, based on the selected document set identifier.
